(19) United States
(12) Patent Application Publication
(10) Pub. No.: US 2021/0392146 A1
(43) Pub. Date: Dec. 16, 2021

(54) Machine Learning-based user and entity behavior analysis for network security

(71) Applicant: Zscaler, Inc., San Jose, CA (US)

(72) Inventors: Dianhuan Lin, Sunnyvale, CA (US); Changsha Ma, Campbell, CA (US); Xuan Qi, Cupertino, CA (US); Rex Shang, Los Altos, CA (US); Douglas A. Koch, Santa Clara, CA (US); Birender Singh, San Jose, CA (US); Howie Xu, Palo Alto, CA (US)

(21) Appl. No.: 16/902,681

(22) Filed: Jun. 16, 2020

(51) Int. Cl. H04L 29/06; G06N 20/00; G06F 21/31

(52) U.S. Cl. CPC H04L 63/1416; G06F 21/316; G06N 20/00

(57) ABSTRACT

Systems and methods include utilizing a grouping model to identify a function of a user of a tenant; utilizing one or more behavior models to identify normal behavior and abnormal behavior of the user based on the function; and utilizing an orchestration model with a plurality of rules to score one or more of current and historical behavior of the user, based on the one or more behavior models; and utilizing an active learning model to improve the efficiency of the orchestration model The systems and methods can further include causing a security technique based on the score. The systems and methods can further include providing feedback based on the score to the one or more behavior models.

### FIELD OF THE DISCLOSURE

The present disclosure relates generally to Machine Learning (ML) systems and methods for use in networking and cloud computing. More particularly, the present disclosure relates to systems and methods for Machine Learning (ML)-based User and Entity Behavior Analysis (UEBA).

### BACKGROUND OF THE DISCLOSURE

Machine learning techniques are proliferating and offer many use cases, especially in network and computer security (which are referred to herein as simply network security). In network security, use cases for machine learning include malware detection, identifying malicious files for further processing such as in a sandbox, user or content risk determination, intrusion detection, behavior analysis, etc. The general process includes training where a machine learning model is trained on a dataset, e.g., data including malicious and benign content or files, data including normal and abnormal behavior, etc., and, once trained, the machine learning model is used in production (i.e., serving, operation) to perform some classification based on current data and the training data. An outcome of the classification is used for a security technique, such as blocking/allowing content, blocking/allowing access, flagging/alerting risk, further processing of content such as in a sandbox, etc.

In terms of network security, three existing problems, i.e., “pain points,” include the fact human operators are mistake-prone, there are simply not enough security experts, and a security posture is often a step or more behind. First, human classification in security techniques is not always accurate, e.g., classification of sites such as phishing versus malicious sites, behavior classification as normal or abnormal, etc. Incorrect classification can cause security risks (where a site or action is improperly allowed), poor user experience (where a site or action is wrongly blocked), etc. The question is whether ML can provide an ability to detect errors in such classifications. Second, there are simply not enough security experts to satisfy all of the needs. As such, the opportunity is for ML to offer enhancements to the existing security teams to expand their reach and scope. Finally, the security posture, namely the configuration, policies, threat data, white/blacklists, dictionaries, libraries, etc., are always behind the curve. That is, existing security is reactive as opposed to proactive. The question then is whether ML can provide proactive insights to suggest timely actionable items in advance.

### BRIEF SUMMARY OF THE DISCLOSURE

The present disclosure relates to systems and methods for Machine Learning (ML)-based user and entity behavior analysis. Specifically, the user and entity behavior analysis includes multiple ML models that may be used individually or in combination to perform various network security functions. The ML models include a user grouping model, an orchestration model, behavior models, and an active learning model. The user grouping model has the objective of identifying peers for a user for comparison with the identification because a user may belong to more than one group (e.g., human resources, sales, finance, marketing, operations, etc.) and the traditional approach of labeling a user based on his or her department may be missing, out of date, inaccurate, etc. The orchestration model is used in production with identified behavior, grouping, etc. and associated rules to determine if the ongoing activity for a user is normal or abnormal, i.e., a risk or not. The behavior models operate to identify the normal or abnormal for a given group of users from different perspectives, e.g., it would be normal for a finance person to visit a paycheck service online at a given time each month, it would be abnormal for a salesperson to download at one time a large about of data from a Customer Relationship Manager (CRM) program, etc. To avoid alert fatigue, the active learning model is used in the feedback loop to select a subset of alerts to be sent to SOC (security operations center). The alerts are selected in a way with little compromise on the feedback signal. Advantageously, the combination of ML models can be used to identify malicious insiders, compromised users, unintended access, departing users, etc.

Systems and methods include steps of utilizing a grouping model to identify a function of a user of a tenant; utilizing one or more behavior models to identify normal behavior and abnormal behavior of the user based on the function; and utilizing an orchestration model with a plurality of rules to score one or more of current and historical behavior of the user, based on the one or more behavior models. The steps can further include causing a security technique based on the score. The steps can further include providing feedback based on the score to the one or more behavior models. The steps can further include providing multi-tenant insights as feedback. The grouping model can utilize a clustering technique to identify the function from a plurality of functions. The orchestration model can include a plurality of input features from the one or more behavior models and performs comparisons based on peers for the function and based on the user's historical behavior. The one or more behavior models can define the normal behavior and the abnormal behavior for the function in terms of one or more of Uniform Resource Locator (URL) access, bandwidth, and app usage. The abnormal behavior can include the user being suspected of leaving the tenant.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a cloud-based system for implementing various cloud-based services;

FIG. 2 is a block diagram of a server which may be used in the cloud-based system of FIG. 1 or the like;

FIG. 3 is a block diagram of a user device which may be used in the cloud-based system of FIG. 1 or the like;

FIG. 4 is a block diagram of an ML-based UEBA system including a user grouping model, an orchestration model, and behavior models and an active learning model;

FIG. 5 is a graph from an example operation of a clustering technique for identifying job functions;

FIG. 6 is a block diagram of details of the orchestration model;

FIG. 7 is a three-dimensional graph illustrating behavior for a normal employee persona and an abnormal employee persona;

FIG. 8 is two graphs over time illustrating Salesforce downloads and Filehost uploads for an example employee who later departs for a competitor;

FIG. 9 are graphs of an individual user and group of users illustrating Salesforce downloads and Filehost uploads;

FIG. 10 is a graph illustrating an example self-comparison;

FIG. 11 is a graph illustrating an example peer-to-peer comparison;

FIG. 12 is a graph of an anomaly analysis based on transmitted bytes; and

FIG. 13 is a flowchart of a user and entity behavior analysis process,

### DETAILED DESCRIPTION OF THE DISCLOSURE

The present disclosure relates to systems and methods for Machine Learning (ML)-based user and entity behavior analysis. Specifically, the user and entity behavior analysis includes multiple ML models that may be used individually or in combination to perform various network security functions. The ML models include a user grouping model, an orchestration model, behavior models, and an active learning model. The user grouping model has the objective of identifying peers for a user for comparison with the identification because a user may belong to more than one group (e.g., human resources, sales, finance, marketing, operations, etc.) and the traditional approach of labeling a user based on his or her department may be missing, out of date, inaccurate, etc. The orchestration model is used in production with identified behavior, grouping, etc. and associated rules to determine if the ongoing activity for a user is normal or abnormal, i.e., a risk or not. The behavior models operate to identify the normal or abnormal for a given group of users from different perspectives, e.g., it would be normal for a finance person to visit a paycheck service online at a given time each month, it would be abnormal for a salesperson to download at one time a large about of data from a Customer Relationship Manager (CRM) program, etc. To avoid alert fatigue, the active learning model is used in the feedback loop to select a subset of alerts to be sent to SOC (security operations center). The alerts are selected in a way with little compromise on the feedback signal. Advantageously, the combination of ML models can be used to identify malicious insiders, compromised users, unintended access, departing users, etc. Again, each of the ML models described herein—the user grouping model, the orchestration model, and the behavior model—can be used individually or in combination.

The present disclosure contemplates use in network security in an embodiment, including inline security systems in the cloud that monitor data between the Internet, enterprises, and users. Advantageously, the combination of ML models can be used to identify malicious users, compromised users, unintended access, departing users, etc. Specifically, an output of the ML models can identify risk scores for users, groups of users, companies, etc., and such scores can be used to surface malicious insiders, compromised users, unintended privileged access, departing/departed employee anomalies, etc. In network security, the ML models can be used in cloud-based security, Secure Web Gateways (SWG), Cloud Access Security Brokers (CASB), Data Leakage Prevention (DLP), etc. Other embodiments and use cases, including areas outside of network security, are also contemplated.

Example Cloud System Architecture

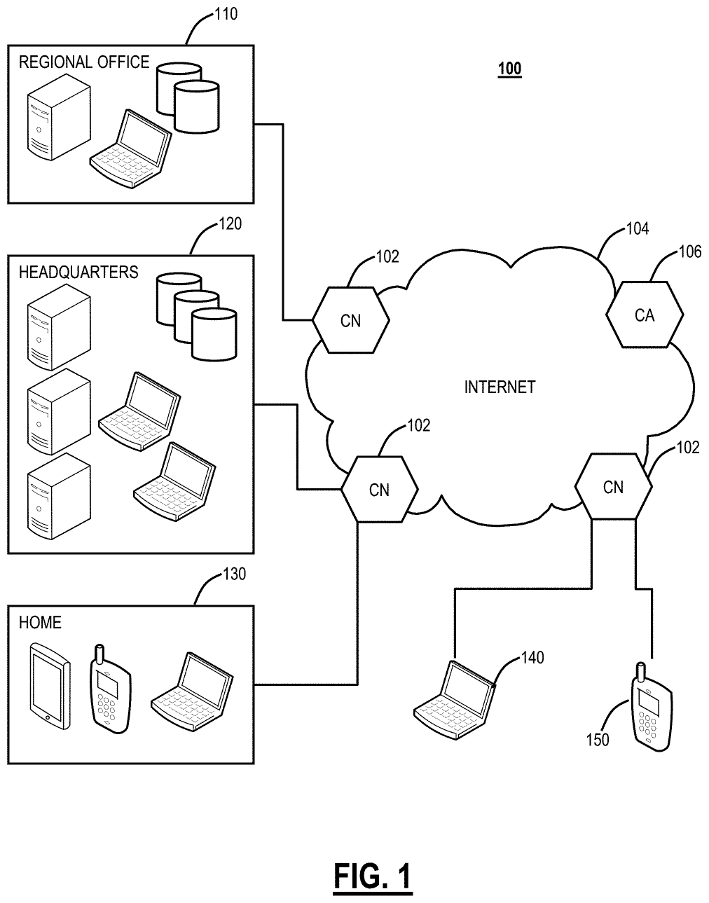

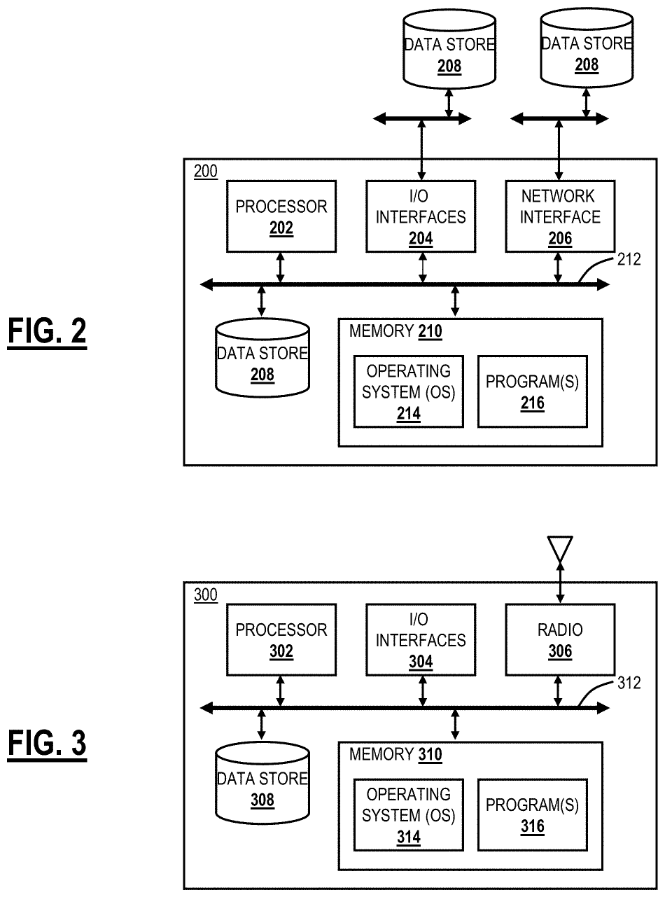

FIG. 1 is a network diagram of a cloud-based system 100 for implementing various cloud-based services. The cloud-based system 100 includes one or more Cloud Nodes (CN) 102 communicatively coupled to the Internet 104 or the like. The cloud nodes 102 may be implemented as a server 200 (as illustrated in FIG. 2) or the like and can be geographically diverse from one another, such as located at various data centers around the country or globe, at customer locations, etc. Further, the cloud-based system 100 can include one or more Central Authority (CA) nodes 106, which similarly can be implemented as the server 200 and be connected to the cloud nodes 102. For illustration purposes, the cloud-based system 100 can connect to a regional office 110, headquarters 120, various employee's homes 130, laptops/desktops 140, and mobile devices 150, each of which can be communicatively coupled to one of the cloud nodes 102. These locations 110, 120, 130, and devices 140, 150 are shown for illustrative purposes, and those skilled in the art will recognize there are various access scenarios to the cloud-based system 100, all of which are contemplated herein. The devices 140, 150 can be so-called road warriors, i.e., users off-site, on-the-road, etc. The cloud-based system 100 can be a private cloud, a public cloud, a combination of a private cloud and a public cloud (hybrid cloud), or the like.

Again, the cloud-based system 100 can provide any functionality through services such as Software as a Service (SaaS), Platform as a Service (PaaS), Infrastructure as a service, security as a service (IaaS), Virtual Network Functions (VNFs) in a Network Functions Virtualization (NFV) Infrastructure (NFVI), etc. to the locations 110, 120, 130 and devices 140, 150. Previously, the Information Technology (IT) deployment model included enterprise resources and applications stored within an enterprise network (i.e., physical devices) behind a firewall (perimeter), accessible by employees on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein contemplate operation with any cloud-based system.

There has been unprecedented growth in cloud services for enterprises and their employees, contractors, partners, etc. Traditionally, enterprises have deployed one secure application for each service for each platform, but this has failed to scale with the growth of mobility in Information Technology (IT). There are myriad numbers of cloud services that are being accessed from various devices, including unmanaged endpoint user devices, across diverse operating systems, uncontrolled network topologies, vaguely understood mobile geographies, and the like. The cloud has presented numerous challenges to IT administrators, including Information Security Offices (ISOs). The traditional approach to network security included network perimeter defense, and this made sense with applications and data hosted in a data center and with users located on a secure, enterprise network (or connected thereto via a Virtual Private Network (VPN)). However, with applications and data moving to the cloud, and with users becoming increasingly mobile, the traditional approach does not work (i.e., does not scale, leads to poor user experience, etc.). That is, cloud services are meant to be accessed directly, not rerouted through VPNs, etc. Stated differently, the secure, enterprise network that once sat behind a secure perimeter is now on the Internet. As such, the only approach for network security is via a cloud service itself, such as via the cloud-based system 100.

In an embodiment, the cloud-based system 100 can be a distributed security system or the like, to provide network security. Here, in the cloud-based system 100, traffic from various locations (and various devices located therein) such as the regional office 110, the headquarters 120, various employee's homes 130, laptops/desktops 140, and mobile devices 150 can be monitored via redirection, a proxy, traffic forwarding, etc. to the cloud through the cloud nodes 102. That is, each of the locations 110, 120, 130, 140, 150 is communicatively coupled to the Internet 104 and can be monitored by the cloud nodes 102. The cloud-based system 100 may be configured to perform various functions such as spam filtering, Uniform Resource Locator (URL) filtering, antivirus protection, bandwidth control, Data Leakage Prevention (DLP), zero-day vulnerability protection, web 2.0 features, and the like. In an embodiment, the cloud-based system 100 may be viewed as security as a service through the cloud. For example, the cloud-based system 100 can be used to block or allow access to web sites, implement policy, protect against malware, provide DLP, etc.

That is, the cloud-based system 100 can be configured to provide device security and policy systems and methods. The laptops/desktops 140, the mobile device 150, as well as various devices at the locations 110, 120, 130 may be a user device 300 (as illustrated in FIG. 3) and may include common devices such as laptops, smartphones, tablets, netbooks, personal digital assistants, MP3 players, cell phones, e-book readers, Internet of Things (IoT) devices, and the like. The cloud-based system 100 can be configured to provide security and policy enforcement for devices. Advantageously, the cloud-based system 100, when operating as a distributed security system, avoids platform-specific security apps on the mobile devices 150, forwards web traffic through the cloud-based system 100, enables network administrators to define policies in the cloud, and enforces/cleans traffic in the cloud before delivery to the mobile devices 150. Further, through the cloud-based system 100, network administrators may define user-centric policies tied to users, not devices, with the policies being applied regardless of the device used by the user. The cloud-based system 100 provides 24×7 security with no need for updates as the cloud-based system 100 is always up to date with current threats and without requiring device signature updates. Also, the cloud-based system 100 enables multiple enforcement points, centralized provisioning, and logging, automatic traffic routing to the nearest cloud node 102, the geographical distribution of the cloud nodes 102, policy shadowing of users, which is dynamically available at the cloud nodes 102, etc.

The cloud nodes 102 can proactively detect and preclude the distribution of security threats, e.g., malware, spyware, viruses, email spam, DLP, content filtering, suspicious behavior, etc., and other undesirable content sent from or requested by the user device 300. The cloud nodes 102 can also log activity and enforce policies, including logging changes to the various components and settings. The cloud nodes 102 can be communicatively coupled to the user devices 300, providing in-line monitoring. The connectivity between the cloud nodes 102 and the user devices 300 may be via a tunnel (e.g., using various tunneling protocols such as Generic Routing Encapsulation (GRE), Layer Two Tunneling Protocol (L2TP), other Internet Protocol (IP) security protocols, and any tunneling protocol. Alternatively, the connectivity may be via a user application on the user device 300 that is configured to selectively forward traffic through the cloud nodes 102.

That is, there are various techniques to forward traffic between users (locations 110, 120, 130, devices 140, 150) and the cloud-based system 100. Typically, the locations 110, 120, 130 can use tunneling where all traffic is forward, and the devices 140, 150 can use an application, proxy, Secure Web Gateway (SWG), etc. Additionally, the cloud-based system 100 can be multi-tenant in that it operates with multiple different customers (enterprises), each possibly including different policies and rules. One advantage of the multi-tenancy and a large volume of users is the zero-day/zero-hour protection in that a new vulnerability can be detected and then instantly remediated across the entire cloud-based system 100. Another advantage of the cloud-based system 100 is the ability for the central authority nodes 106 to instantly enact any rule or policy changes across the cloud-based system 100. As well, new features in the cloud-based system 100 can also be rolled up simultaneously across the user base, as opposed to selective upgrades on every device at the locations 110, 120, 130, and the devices 140, 150.

The central authority nodes 106 can store policy data for each organization and can distribute the policy data to each of the cloud nodes 102. The central authority nodes 106 can also distribute threat data that includes the classifications of content items according to threat classifications, e.g., a list of known viruses, a list of known malware sites, spam email domains, a list of known phishing sites, a DLP dictionary, etc. The conventional deployment relied on physical devices located at the perimeter of the enterprise network. The cloud-based system 100 removes the need for such devices as well as the management thereof and provides security anywhere, anytime, on any system.

As described herein, the terms cloud services and cloud applications may be used interchangeably. A cloud service is any service made available to users on-demand via the Internet, such as via the cloud-based system 100 as opposed to being provided from a company's own on-premises servers. A cloud application, or cloud app, is a software program where cloud-based and local components work together. Example cloud services include Zscaler Internet Access (ZIA), Zscaler Private Access (ZPA), and Zscaler Digital Experience (ZDX), from Zscaler, Inc. (the assignee and applicant of the present application). The ZIA service can include firewall, threat prevention, Deep Packet Inspection (DPI), DLP, content filtering, and the like. The ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources in lieu of traditional Virtual Private Networks (VPNs), namely ZPA provides ZTNA. Those of ordinary skill in the art will recognize various other types of cloud services are also contemplated. In fact, the trend is for all computing services to move to the cloud include, for example, document management, file storage, Customer Relationship Management (CRM), email, billing, finance, etc. In the context of these services, a provider of such cloud services can be referred to as a cloud provider, a SaaS provider, etc., and may utilize a hardware architecture similar to the cloud-based system 100. Of course, other types of cloud architectures are also contemplated, with the cloud-based system 100 presented for illustration purposes.

Logically, as a distributed security system, the cloud-based system 100 can be viewed as an overlay network between users (at the locations 110, 120, 130, and the devices 140, 150) and the Internet 140. As mentioned herein, the conventional security approach relies upon physical devices and/or appliances located at the perimeter of the enterprise network. As an ever-present overlay network, the cloud-based system 100 can provide the same functions as the physical devices and/or appliances regardless of geography or location of the users (at the locations 110, 120, 130 and the devices 140, 150), as well as independent of platform, operating system, network access technique, network access provider, etc.

Example Server Architecture

FIG. 2 is a block diagram of a server 200, which may be used in the cloud-based system 100, in other systems, or standalone. For example, the cloud nodes 102 and the central authority nodes 106 may be formed as one or more of the servers 200. The server 200 may be a digital computer that, in terms of hardware architecture, generally includes a processor 202, Input-Output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter (e.g., 10BaseT, Fast Ethernet, Gigabit Ethernet, 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, the software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Example User Device Architecture

FIG. 3 is a block diagram of a user device 300, which may be used in the cloud-based system 100 or the like. Again, the user device 300 can be a smartphone, a tablet, a smartwatch, an Internet of Things (IoT) device, a laptop, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 3 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

Machine Learning in Network Security

Again, machine learning can be used in various applications, including malware detection, intrusion detection, threat classification, the user or content risk, detecting malicious clients or bots, intrusion detection, behavior analysis, etc. In the context of the cloud-based system 100 as an inline security system, machine learning can be used on a content item, e.g., a file, to determine if further processing is required during inline processing. For example, machine learning can be used in conjunction with a sandbox to identify malicious files. A sandbox, as the name implies, is a safe environment where a file can be executed, opened, etc. for test purposes to determine whether the file is malicious or benign. It can take a sandbox around several minutes before it is fully determined whether the file is malicious or benign. Of course, inline monitoring is just one possible use case, and various other embodiments are also possible.

Machine learning can determine a verdict in advance before a file is sent to the sandbox. If a file is predicted as benign, it does not need to be sent to the sandbox. Otherwise, it is sent to the sandbox for further analysis/processing. Advantageously, utilizing machine learning to pre-filter a file significantly improves user experience by reducing the overall quarantine time as well as reducing workload in the sandbox. Further, it follows that the machine learning predictions require high precision due to the impact of a false prediction, i.e., finding a malicious file to be benign. Machine learning can compensate a sandbox result to provide better zero-day malware detection.

In the context of inline processing, sandboxing does a great job in detecting malicious files, but there is a cost in latency, which affects user experience. Machine learning can alleviate this issue by giving an earlier verdict on the static files. However, it requires ML to have extremely high precision, since the cost of a false positive and false negative are very high. For example, a benign hospital life-threatening file, if mistakenly blocked due to an ML model's wrong verdict, would cause a life disaster. Similarly, undetected ransomware could cause problems for an enterprise. Therefore, there is a need for a high-precision approach for both benign and malicious files.

A description utilizing machine learning in the context of malware detection is described in commonly-assigned U.S. patent application Ser. No. 15/946,706, filed Apr. 5, 2018, and entitled “System and method for malware detection on a per packet basis,” the content of which is incorporated herein by reference in its entirety. Another example of improving machine learning precision is described in commonly-assigned U.S. patent application Ser. No. 16/377,129, filed Apr. 5, 2019, and entitled “Prudent ensemble models in machine learning with high precision for use in network security,” the content of which is incorporated herein by reference. This disclosure focuses on identifying blind spots in a model and discarding classification results landing in the blind spots. Yet another example of machine learning in network security is described in commonly-assigned U.S. patent application Ser. No. 16/542,385, filed Aug. 16, 2019, and entitled “Pattern similarity measures to quantify uncertainty in malware classification,” the content of which is incorporated herein by reference in its entirety. This disclosure utilizes patterns in ML models to quantify the uncertainty in a classification result.

Machine Learning-Based User and Entity Behavior Analysis (UEBA)

The present disclosure provides three additional ML models, namely the user grouping model, the orchestration model, the active learning model and the behavior models, which collectively perform User and Entity Behavior Analysis (UEBA). Outputs of the UEBA are used in the context of network security, again to identify malicious insiders, compromised users, unintended privileged access, departing/departed employee anomalies, etc. In network security, the ML models can be used in cloud-based security, Secure Web Gateways (SWG), Cloud Access Security Brokers (CASB), Data Leakage Prevention (DLP), etc. Those skilled in the art will recognize other embodiments and use cases, including areas outside of network security, are also contemplated.

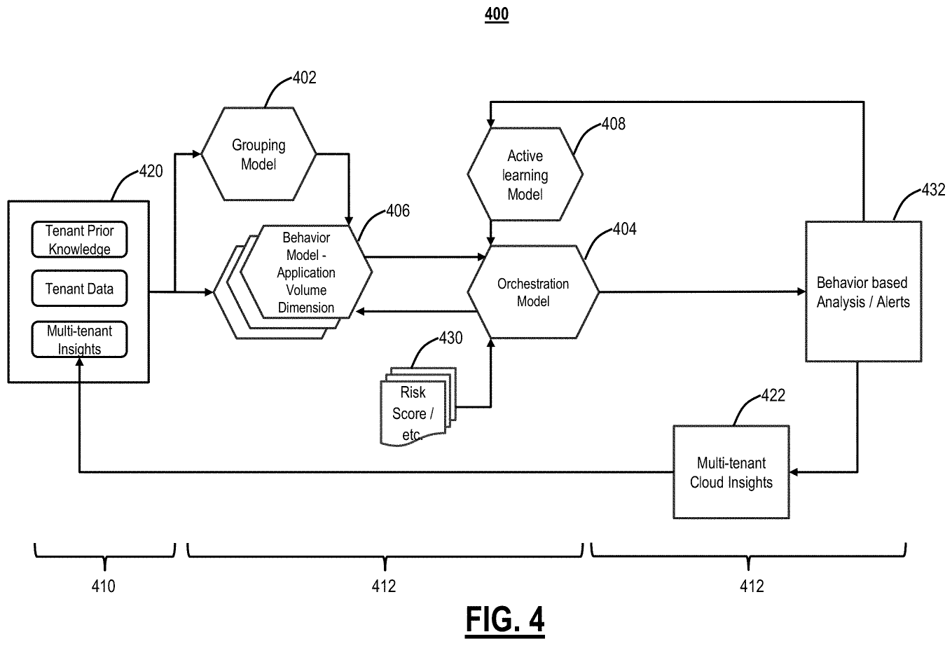

FIG. 4 is a block diagram of an ML-based UEBA system 400, including a user grouping model 402, an orchestration model 404, behavior models 406, and an active learning model 408. In FIG. 4, each of the ML models 402, 404, 406, 408 is described in combination with one another; however, those of ordinary skill in the art will recognize any of the models 402, 404, 406, 408 can be used individually or in combination. For illustration purposes only, the models 402, 404, 406, 408 are illustrated in combination with one another in FIG. 4. The ML-based UEBA system 400 can be used in combination with the cloud-based system 100 operating as a distributed security system. Also, the ML-based UEBA system 400 contemplates use with other types of security systems, including appliance-based systems, non-cloud-based systems, software security applications, and the like.

The ML-based UEBA system 400 includes three general steps, including data collection and processing (step 410), model training and serving (step 412), and output, visualization, and/or feedback (step 414). The data collection and processing step 410 includes obtaining data 420, such as, without limitation tenant prior knowledge data, tenant operational data, multi-tenant insights. As described herein, a tenant is an entity associated with the ML-based UEBA system 400. A tenant may include an enterprise, a corporation, an organization, etc. That is, a tenant is a group of users who share a common access with specific privileges to the cloud-based system 100, a cloud service, etc.

The three categories of the data 420 can include prior knowledge data, current operational data, and feedback data, i.e., multi-tenant insights 422. The prior knowledge data can be user lists, accounts, labels associated with users, location, etc., i.e., any predetermined data. The current operational data includes current data, e.g., user browsing information, user bandwidth usage, cloud service usage, etc. Finally, the multi-tenant insights 422 leverage the fact the ML-based UEBA system 400 is multi-tenant and utilizes insights gained from one tenant for other tenants, albeit in a secure, anonymized manner (i.e., sensitive tenant data is not shared between tenants, but is used in feedback.

The model training and serving step 412 is configured to train the models 402, 404, 406, 408 based on the data 420. Again, the user grouping model 402 has the objective of identifying peers for a user for comparison with the identification because a user may belong to more than one group (e.g., human resources, sales, finance, marketing, operations, etc.) and the traditional approach of labeling a user based on his or her department may be missing, out of date, inaccurate, etc. An input to the user grouping model 402 can be application or documents access logs for a tenant, and an output can include a peer group. The peer group identifies other users who share similar functionality and network behaviors. The peer group can be utilized in the behavior model 406 and the orchestration model 404 for normal/abnormal behavior analysis.

The orchestration model 404 is used in production with identified behavior, grouping, etc. and associated rules to determine if the ongoing activity for a user is normal or abnormal, i.e., a risk or not. An input to the orchestration model 404 includes the operational data associated with a user, and an output includes an indication of whether ongoing behavior is normal or abnormal. The behavior models 406 can be the input to the orchestration model 404. The orchestration model 404 provides a summarization step which takes correlation from different behavior models 404 and provides a more complete picture.

The behavior models 406 operate to identify the normal or abnormal for a given group of users, i.e., peers based on the grouping model 402. For example, it would be normal for a finance person to visit a paycheck service online at a given time each month, it would be abnormal for a salesperson to download at one time a large amount of data from a Customer Relationship Manager (CRM) program, etc.

In the ML-based UEBA system 400, the grouping model 402 is connected to the data 420, as well as providing its output to the behavior models 406. The behavior models 406 also receives inputs from the data 420, as well as risk score 430 information. The risk score information could contain the alerts provided by endpoint detection and response vendors. An output of the orchestration model 404 is provided to the active learning model 408. The orchestration model 404 outputs behavior-based analysis/alerts 432, which are used to provide feedback to the active learning model 408 and the multi-tenant cloud insights 422. The active learning model 408 can use the feedback to determine whether or not a specific classification, i.e., user risk score or alert, was correct or not. This active learning model 408 is used to improve the models 402, 404, 406.

The behavior-based analysis/alerts 432 can be utilized in security processing, third party product integration, etc. For example, in the cloud-based system 100 operating a cloud security services, the behavior-based analysis/alerts 432 can be used for user risk scores, company scores, etc. to surface malicious insiders, compromised users, unintended privileged access, departing/departed employees, incident prioritization, etc. The behavior-based analysis/alerts 432 can be used for DLP, etc. UEBA can be used with various security functions, such as, for example, CASB, Data-Centric Audit and Protection (DACP), DLP, employee monitoring, endpoint security, fraud, Identity and Access Management (IAM), STEM, Network Traffic Analysis (NTA), etc.

Grouping Model

The grouping model 402 is configured to identify a job function and peers for comparison with a given user. Again, the rationale for an ML model to group a user is that human classification is error-prone. The traditional approach is to simply assign a user a department and assume the peer comparison is other users in the same department. This is problematic as active directory, and department information may be missing, inaccurate, or outdated. It is further problematic that users in the same department may have different personas and behavior patterns.

For training, the grouping model 402 builds a persona for a plurality of different functions. As described herein, the persona is developed based on the data 420, including application (“app”) usage, URL history, cloud service usage, location, bandwidth usage, etc. The persona describes what a specific job function should expect. The training can be based on known data 420 for specific job functions. In an embodiment, the specific job functions include, without limitation, sales, marketing, operations, finance, human resources, legal, engineering, etc. In another embodiment, the specific job functions can be more granular. Sales, for more granularity, can include field sales, sales engineering, outside sales, inside sales, business development, sales executives. Engineering, for more granularity, can include software, hardware, testing, etc. Those skilled in the art will recognize any type of job function can be used.

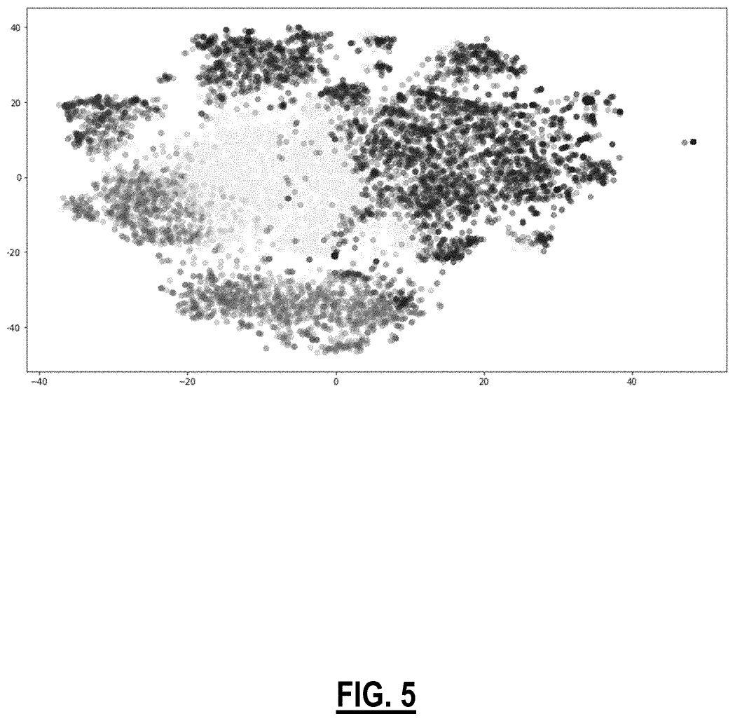

For training, the data 420 includes data associated with any of app usage, URL history, cloud service usage, location, bandwidth usage, etc. labeled with job functions. This can be performed on a per-tenant basis, and can also be extended to a multi-tenant basis. In an embodiment, the job functionality can be identified using user app usage activity and a clustering technique, such as a K-means. FIG. 5 is a graph from an example operation of a clustering technique for identifying job functions. FIG. 5 includes six different job functions, and an unknown user can be classified based on his or her app usage activity and where it lands in the graph. For the training data, various users with known job functions can be classified based on their app data. The following table illustrates an example of training data, utilizing factors including active days (such as in a time period, e.g., a month), active Salesforce usage (CRM), active Bitbucket (software code management) usage, and active other app usage.

| | Active | Active | Active Bitbucket | Active other app |
|---|---|---|---|---|
| | days | Salesforce usage | usage | usage |
| user_1 | 28 | 20 (days) | 3 (days) | 28 (days) |
| user_2 | 27 | 0 (day) | 21 (days) | 27 (days) |
| . . . | | | | |

In the table above, user_1 can be a salesperson, whereas user_2 can be a software developer.

Orchestration Model

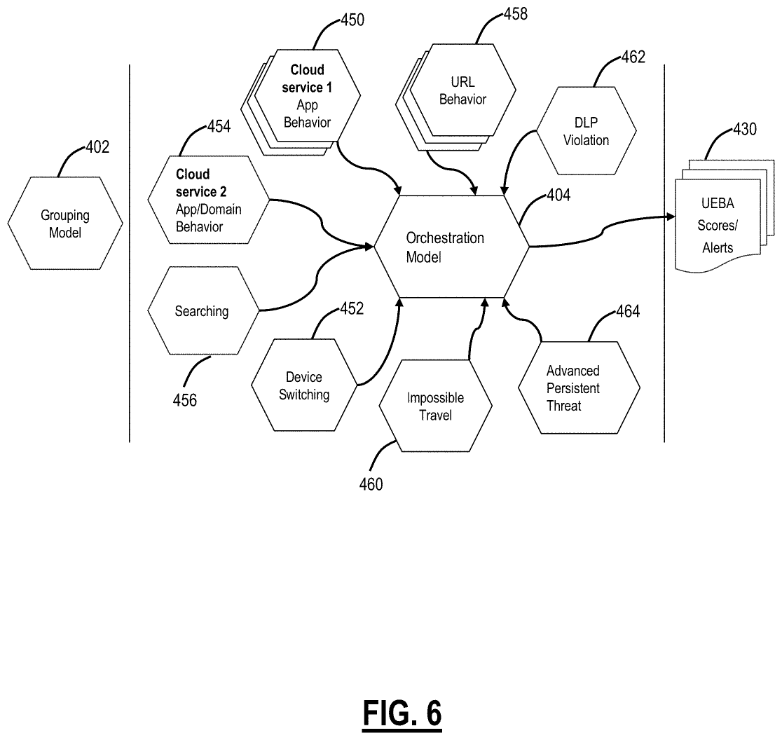

FIG. 6 is a block diagram of details of the orchestration model 404. Again, the orchestration model 404 accepts input from the behavior models 406. As described herein, the behavior models 406 receive the input 420 including tenant data that includes current operational data for a user and an output of the grouping model 402 for the user that identifies the user's function. Alternatively, the grouping model 402 can be omitted, and the user's function can be identified in other ways, e.g., manually specified, etc., to the behavior models 406.

The output of the orchestration model 404 is the behavior-based analysis/alerts 432, which quantifies the risk of the user based on the data 420 and the user's function. The outcome of orchestration model 404 can be a set of (1) high confident positive, and (2) high confident negative detections. That is, the orchestration model 404 can take as inputs 450-464 which are outputs from the behavior models 406 and produce an output, insight, risk score, actionable item, alert, etc. In an embodiment, the orchestration model 404 can be a set of rules includes positive detection rules, false positive detection rules, etc. The set of rules can be heuristically derived as well as derived through machine learning.

The orchestration model 404 can be represented by a set of rules. For example, the rules can be heuristically derived, as well as ML derived (data-driven). Some example positive detection rules can include, with limitation, 1) high volume of sanctioned app download, followed by high volume unsanctioned app upload, 2) high volume of Salesforce download plus a variety of newly visited opportunity documents, 3) impossible travel 460 plus APT 464, and the like. These example rules 1)-3) can indicate a user is a high-risk—for the rules 1)-2), the user may be likely to leave the company with data, and for rule 3), the user can be at risk of being compromised. Those skilled in the art will recognize various types of rules are possible. Further, the rules can be both tenant-specific as well as applicable to multiple tenants.

Example Behavior Models

In the example of FIG. 6, the orchestration model 404 includes inputs 450-464 from corresponding behavior models 406. Each behavior models 406 provide a correlation signal for the orchestration model 404 to make the decision. In an embodiment, the inputs 450-464 include a cloud service 1 app behavior 450, device switching 452, a cloud service 2 app behavior 454, searching 456, URL behavior 458, impossible travel 460, DLP violations 462, and advanced persistent threats 464. Specifically, the input features 450-464 are from the data 420. The behavior 450, 454 from two different cloud services, such as, for example, ZIA and ZPA as described above. Of course, this could be from other cloud services. The URL behavior 458 includes URL access activity by a user. The DLP violation 462 includes any detected DLP violations. Those skilled in the art will appreciate there are various other input features possible from different behavior models 406.

The device switching 452 determines a compromised account as a result in a device changing from one operating system to another, e.g., Mac OS to Windows OS. For example, if a user typically using Mac OS, while suddenly Windows OS showed up in some transactions, that could result from account being compromised. Also, this data can be noisy due to Virtual Machines, where a single machine can have more than one operating system. Thus, rule-based or heuristic approaches are not applicable due to the noisy data. The device switching 452 can include ML-detected unusual device switching such as by a self-comparison: is a device switching abnormal according to past behavior, and a peer-to-peer comparison: is a device switching abnormal compared to peers? Is it more common for software engineers to use Virtual Machine, while less common for HR/Sales?

The searching 456 looks at accessing abnormal higher number of internal domains (e.g., ZPA) or cloud apps (e.g., ZIA) indicates searching (hacker searches for crown jewelers within the environment). The signal of searching can be measured by the abnormal increase in the variety of apps/domains being accessed.

The impossible travel 460 includes the geolocation, IP address, etc. where the user is located, and looks at impossible location changes. For example, a location change from San Francisco to Russia within an hour is impossible, indicating a compromised account. It is important to use ML techniques to determine the impossible travel 460 because location data is not always accurate, i.e., it can be noisy data due to the usage of VPNs (location changes based on the VPN) and the IP address lookup is not always accurate. Thus, rule-based or heuristic approaches are not applicable due to the noisy data. The impossible travel 460 can include ML-detected unusual locations, such as a self-comparison: is an access location abnormal according to past behavior, and a peer-to-peer comparison: is an access location abnormal compared to peers.

The advanced persistent threats 464 can include APT detection on each cloud-service transaction. One transaction alone being flagged with APT does not seem to be serious, however if the behavior continues frequently, then it could become alarming. Each APT corresponds to pre-infection or post-infection and there can be a mapping. The pre-infection or post-infection provides more contexts to other events (e.g., impossible travel).

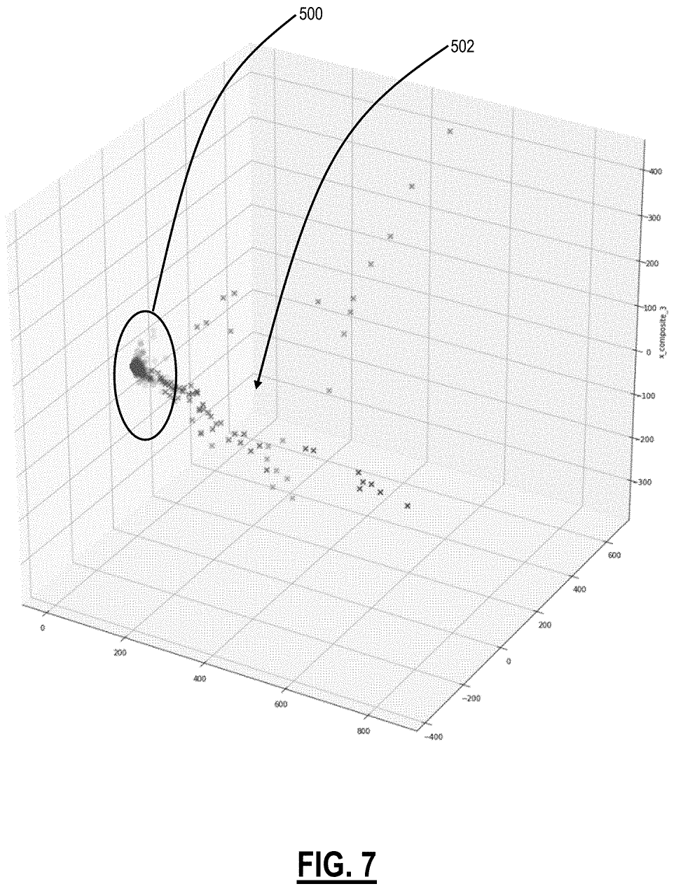

URL categories provide rich context for user persona, including legal reliability (e.g., drug, gambling), productivity (e.g., gaming, low professional activity, social networking), infection risk (e.g., spyware, phishing websites), etc. FIG. 7 is a three-dimensional graph illustrating behavior for a normal employee persona 500 and an abnormal employee persona 502. By analyzing how browsing activity spreads on different URL categories, it is possible to 1) build a baseline of normal employee persona 500; 2) to find out the abnormal persona 502. URLs can be categorized in various different categories. The following URL visits illustrate two abnormal persona examples.

[[84791, ‘Fri Jan 3 00:00:00 2020’], [′ALCOHOL TOBACCO′, ‘ANONYMIZER’, ‘ART_CULTURE’, ‘BLOGS’, ‘BUSINESS_AND _ECONOMY’, ‘CDN’, ‘CLASSIFIEDS’, ‘CONTINUING_EDUCATION _COLLEGES’, ‘CORPORATE_MARKETING’, ‘CUSTOM_02’, ‘CUSTOM_03’, ‘CUSTOM_05’, ‘CUSTOM_07’, ‘CUSTOM_08’, ‘CUSTOM_09’, ‘CUSTOM_11’, ‘CUSTOM_19’, ‘CUSTOM_21’, ‘CUSTOM_27’, ‘CUSTOM_47’, ‘CUSTOM_50’, ‘CUSTOM_52’, ‘CUSTOM_62’, ‘DINING_RESTAURANT’, ‘DISCUSSION_FORUMS’, ‘EDUCATION’, ‘EMAIL_HOST’, ‘ENTERTAINMENT’, ‘FAMILY_ISSUES’, ‘FILE_HOST’, ‘GAMBLING’, ‘GAMES’, ‘GOVERNMENT’, ‘HISTORY’, ‘HOBBIES_LEISURE’, ‘IMAGE_HOST’, ‘INFORMATION_TECHNOLOGY’, ‘INTERNET_SERVICES’, ‘JOB_EMPLOYMENT _SEARCH’, ‘K_12’, ‘MATURE_HUMOR’, ‘MISCELLANEOUS_OR _UNKNOWN’, ‘MUSIC’, ‘NEWS_AND _MEDIA’, ‘NON_CATEGORIZABLE’, ‘ONLINE_AUCTIONS’, ‘ONLINE_CHAT’, ‘POLITICS’, ‘PORTALS’, ‘PROFESSIONAL_SERVICES’, ‘QUESTIONABLE’, ‘REAL_ESTATE’, ‘REFERENCE_SITES’, ‘SCIENCE_TECH’, ‘SHAREWARE_DOWNLOAD’, ‘SHOPPING_AND _AUCTIONS’, ‘SOCIAL_NETWORKING’, ‘SOCIETY_AND _LIFESTYLE’, ‘SPECIALIZED_SHOPPING’, ‘SPECIAL_INTERESTS _SOCIAL_ORGANIZATIONS’, ‘SPORTS’, ‘SPYWARE ADWARE’, ‘STREAMING_MEDIA’, ‘TELEVISION_MOVIES’, ‘TRANSLATORS’, ‘TRAVEL’, ‘VEHICLES’, ‘WEB_BANNERS’, ‘WEB_HOST’, ‘WEB_SEARCH’, ‘XSS’, 950352, 1350852, 1769427, 1769431, 3326747, 3639424, 3712803, 4050694, 4051435, 4051449, 4051550, 4051615, 4051618, 4052262, 4052263, 4052325, 4052326, 4229460, 4350867, 5238112, 6632979, 6632982, 6632985]] [[2834125, ‘Fri Jan 10 00:00:00 2020’], [‘ADULT_MATERIAL’, ‘BLOGS’, ‘BUSINESS_AND _ECONOMY’, ‘CDN’, ‘CLASSIFIEDS’, ‘CONTINUING_EDUCATION _COLLEGES’, ‘CORPORATE_MARKETING’, ‘CUSTOM_02’, ‘CUSTOM_08’, ‘CUSTOM_21’, ‘CUSTOM_27’, ‘CUSTOM_52’, ‘CUSTOM_62’, ‘DINING_RESTAURANT’, ‘DISCUSSION_FORUMS’, ‘EMAIL_HOST’, ‘ENTERTAINMENT’, ‘FILE_HOST’, ‘FINANCE’, ‘GAMBLING’, ‘GAMES’, ‘GOVERNMENT’, ‘HEALTH’, ‘IMAGE_HOST’, ‘INFORMATION_TECHNOLOGY’, ‘INTERNET_SERVICES’, ‘MISCELLANEOUS’, ‘MISCELLANEOUS_OR _UNKNOWN’, ‘MUSIC’, ‘NEWS_AND _MEDIA’, ‘NON_CATEGORIZABLE’, ‘ONLINE_CHAT’, ‘POLITICS’, ‘PROFESSIONAL_SERVICES’, ‘RADIO_STATIONS’, ‘REFERENCE_SITES’, ‘SCIENCE_TECH’, ‘SHAREWARE_DOWNLOAD’, ‘SOCIAL_NETWORKING’, ‘SPECIALIZED_SHOPPING’, ‘SPECIAL_INTERESTS _SOCIAL_ORGANIZATIONS’, ‘SPORTS’, ‘SPYWARE_ADWARE’, ‘STREAMING_MEDIA’, ‘TELEVISION_MOVIES’, ‘TRADITIONAL_RELIGION’, ‘TRANSLATORS’, ‘TRAVEL’, ‘WEB_BANNERS’, ‘WEB_HOST’, ‘WEB_SEARCH’, 6632982]]

Privileged User Activity

In an embodiment, an audit log can be used to identify privileged accounts, i.e., users who control policy configurations. This data can be used to build a profile for these privileged users and monitor their URL behavior and app behavior, to raise alert severity if necessary. The approach introduced in [0058] can also be used to include/exclude high profile users, security operation users, departing users, etc. The CXO accounts contain more critical information, thus higher priority to be protected. Similarly, people who collaborate directly or indirectly with CXO will have more insider information. It is possible to derive a collaboration distance between a user and a CXO based on the past collaboration pattern.

Cloud Monitoring App Behavior

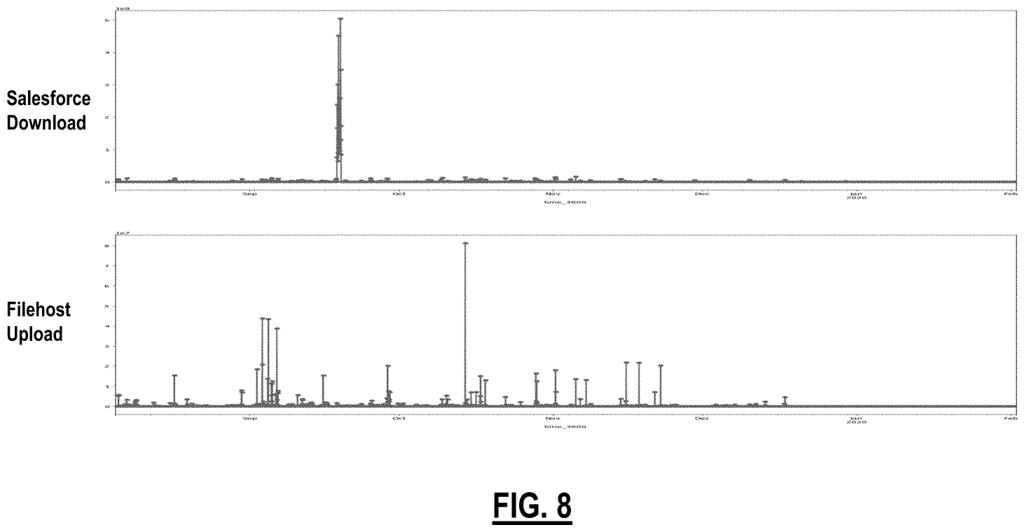

FIG. 8 is two graphs over time illustrating Salesforce downloads and Filehost uploads for an example employee who later departs for a competitor. This is an example of identification of data leakage or trade secret theft risk, namely an employee, contractor, partner, etc. with access to sensitive data who downloads a large portion before leaving.

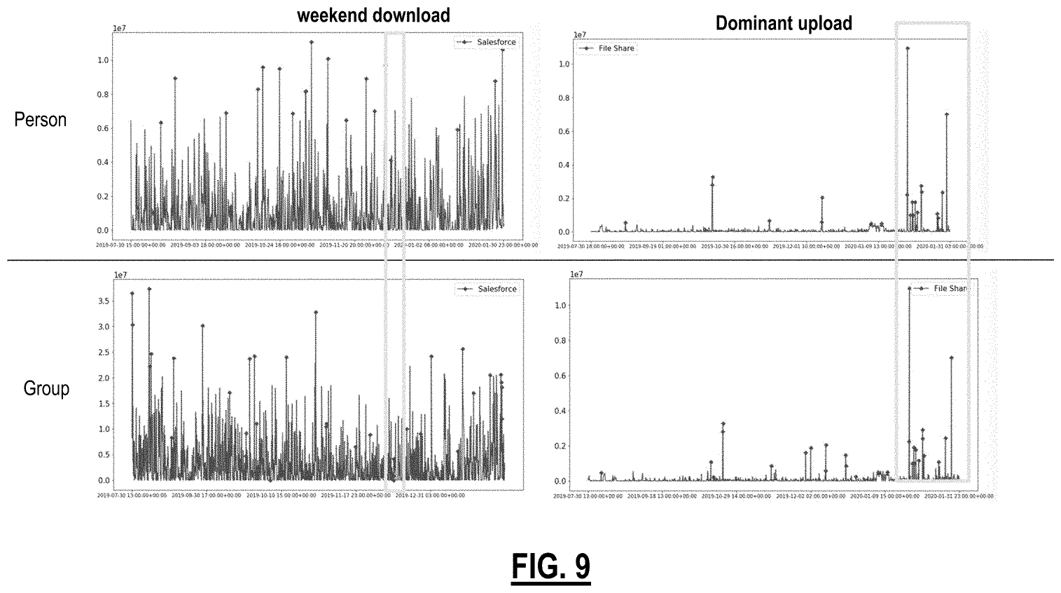

FIG. 9 are graphs of an individual user and group of users illustrating Salesforce downloads and Filehost uploads. Here, the individual user shows high Salesforce downloads over the weekend.

Those skilled in the art will appreciate the cloud-based system 100 can obtain large amounts of data in terms of URL, app, domain, etc. behavior. As such, the ML-based UEBA system 400 can include various rules, correlations, etc. based thereon.

The ML-based UEBA system 400, in the app behavior model 450 and 454, can perform comparisons of the tenant data. The present disclosure contemplates a self-comparison where a user's behavior is compared to the historical behavior of the same user, a peer-to-peer comparison where the user's behavior is compared to other users with the same or similar job function, etc.

For the behaviors 450, 454, behavior can include accessing information outside of the work scope. From the log, it is possible to see who accesses which document. Such information tells a collaboration pattern. People who collaborate on the same documents are either similar function roles or work on the same projects. It is possible to infer which documents a user is likely to access based on the past documents access pattern. The documents that are unlikely to access are likely to be outside work-scope. This ML algorithm is Collaborative Filtering.

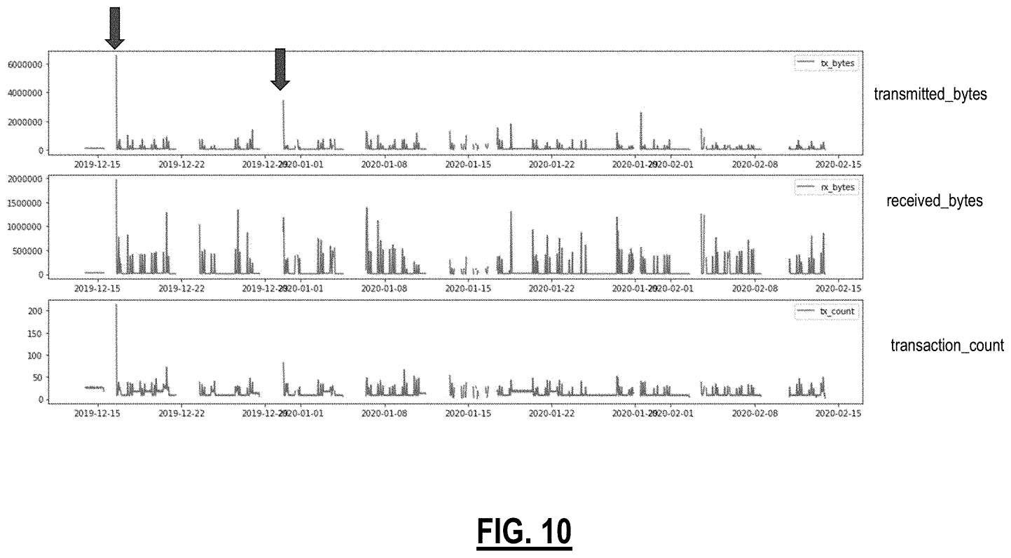

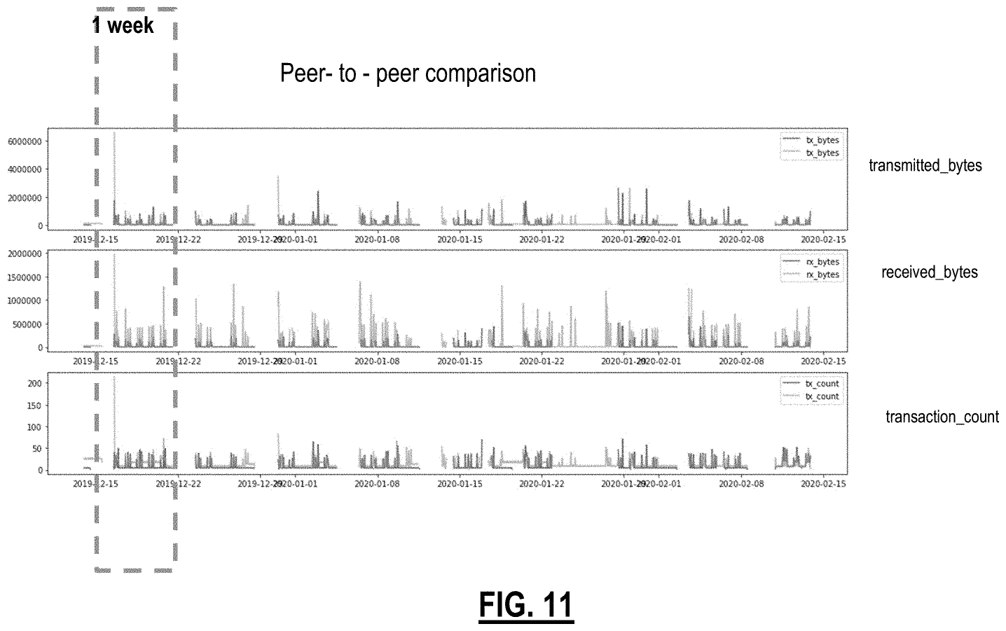

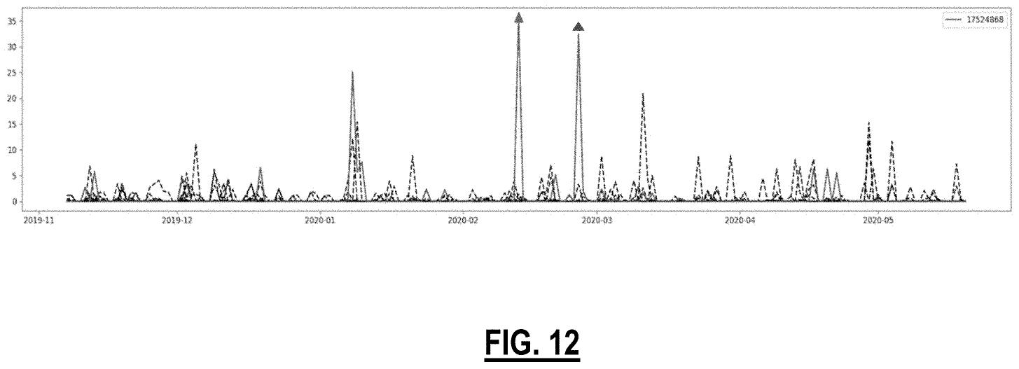

FIG. 10 is a graph illustrating an example of self-comparison. FIG. 11 is a graph illustrating an example of peer-to-peer comparison. FIG. 12 is a graph of an anomaly analysis based on transmitted bytes. FIG. 12 includes a bar graph of peer users (black dash lines), an anomaly user (blue line), and anomaly points highlighted using red triangles. Note, the anomaly analysis can be based on multiple features, including download and upload bytes. The anomaly analysis with the multiple features can be combined to provide a multi-dimensional analysis.

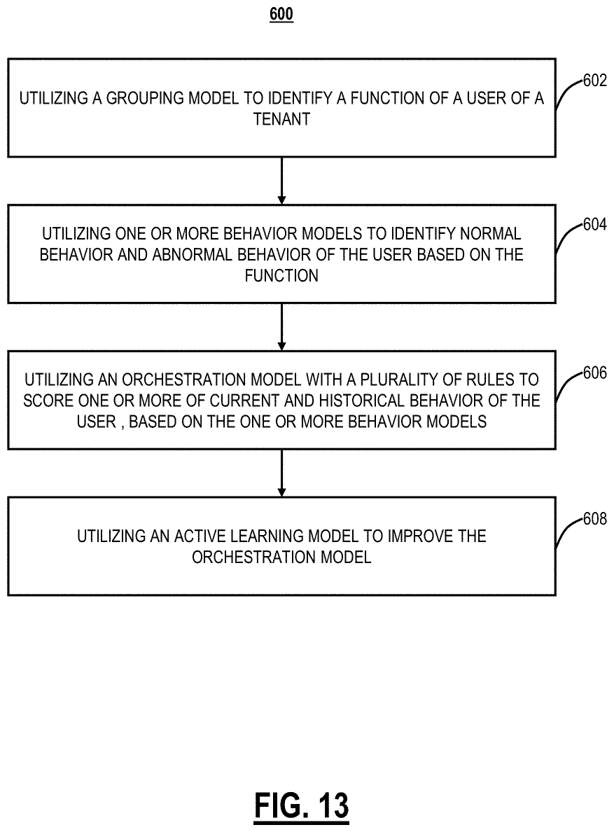

FIG. 13 is a flowchart of a user and entity behavior analysis process 600. The user and entity behavior analysis process 600 can be a computer-implemented method, embodied in a non-transitory computer-readable storage medium having computer-readable code stored thereon for programming one or more processors, and implemented via the server 200.

The process 600 includes utilizing a grouping model to identify a function of a user of a tenant (step 602); utilizing one or more behavior models to identify normal behavior and abnormal behavior of the user based on the function (step 604); utilizing an orchestration model with a plurality of rules to score one or more of current and historical behavior of the user, based on the one or more behavior models (step 606), and utilizing an active learning model to improve the orchestration model (step 608). The process 600 can further include causing a security technique based on the score, e.g., blocking access, raising an alert, etc. The process 600 can further include providing feedback based on the score to the one or more behavior models, i.e., was the classification correct or not, and using this information to better train the models.

The process 600 can further include providing multi-tenant insights as feedback, e.g., using this information to better train the models. The grouping model utilizes a clustering technique to identify the function from a plurality of functions. The orchestration model includes a plurality of input features from the one or more behavior models and performs comparisons based on peers for the function and based on the user's historical behavior. The one or more behavior models define the normal behavior and the abnormal behavior for the function in terms of one or more of Uniform Resource Locator (URL) access, bandwidth, device and app usage. The abnormal behavior includes the user being suspected of leaving the tenant.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A non-transitory computer-readable storage medium having computer-readable code stored thereon for programming one or more processors to perform steps of:
utilizing a grouping model to identify a function of a user of a tenant;
utilizing one or more behavior models to identify normal behavior and abnormal behavior of the user based on the function;
utilizing an orchestration model with a plurality of rules to score one or more of current and historical behavior of the user, based on the one or more behavior models; and
utilizing an active learning model to improve the orchestration model.

2. The non-transitory computer-readable storage medium of claim 1, wherein the steps further include
causing a security technique based on the score.

3. The non-transitory computer-readable storage medium of claim 1, wherein the steps further include
providing feedback based on the score to the one or more behavior models.

4. The non-transitory computer-readable storage medium of claim 1, wherein the steps further include
providing multi-tenant insights as feedback.

5. The non-transitory computer-readable storage medium of claim 1, wherein the grouping model utilizes a clustering technique to identify the function from a plurality of functions.

6. The non-transitory computer-readable storage medium of claim 1, wherein the orchestration model includes a plurality of input features from the one or more behavior models and leverage correlation among different behavior models to reduce false positives.

7. The non-transitory computer-readable storage medium of claim 1, wherein the one or more behavior models define the normal behavior and the abnormal behavior for the function in terms of one or more of Uniform Resource Locator (URL) access, bandwidth, device and app usage.

8. The non-transitory computer-readable storage medium of claim 1, wherein the abnormal behavior includes the user being suspected of leaving the tenant.

9. A system comprising:
a network interface;
a processor communicatively coupled to the network interface; and
memory storing computer-executable instructions that, when executed, cause the processor to
utilize a grouping model to identify a function of a user of a tenant;
utilize one or more behavior models to identify normal behavior and abnormal behavior of the user based on the function;
utilize an orchestration model with a plurality of rules to score one or more of current and historical behavior of the user, based on the one or more behavior models; and
utilize an active learning model to improve the orchestration model.

10. The system of claim 9, wherein the instructions that, when executed, further cause the processor
cause a security technique based on the score.

11. The system of claim 9, wherein the instructions that, when executed, further cause the processor
provide feedback based on the score to the one or more behavior models.

12. The system of claim 9, wherein the instructions that, when executed, further cause the processor
provide multi-tenant insights as feedback.

13. The system of claim 9, wherein the grouping model utilizes a clustering technique to identify the function from a plurality of functions.

14. The system of claim 9, wherein the orchestration model includes a plurality of input features from the one or more behavior models and leverage the correlation among different behavior models to reduce false positives.

15. The system of claim 9, wherein the one or more behavior models define the normal behavior and the abnormal behavior for the function in terms of one or more of Uniform Resource Locator (URL) access, bandwidth, device and app usage.

16. A method comprising:
utilizing a grouping model to identify a function of a user of a tenant;
utilizing one or more behavior models identify normal behavior and abnormal behavior of the user based on the function;
utilizing an orchestration model with a plurality of rules to score one or more of current and historical behavior of the user, based on the one or more behavior models; and
utilizing an active learning model to improve the orchestration model.

17. The method of claim 16, further comprising
causing a security technique based on the score.

18. The method of claim 16, further comprising
providing feedback based on the score to the one or more behavior models.

19. The method of claim 16, further comprising
providing multi-tenant insights as feedback.

20. The method of claim 16, wherein the grouping model utilizes a clustering technique to identify the function from a plurality of functions,
wherein the orchestration model includes a plurality of input features from the one or more behavior models and leverage the correlation among different behavior models to reduce false positives, and
wherein the one or more behavior models define the normal behavior and the abnormal behavior for the function in terms of one or more of Uniform Resource Locator (URL) access, bandwidth, device, and app usage.
